(19) United States
(12) Patent Application Publication
(10) Pub. No.: US 2020/0267459 A1
(43) Pub. Date: Aug. 20, 2020

(54) COORDINATION METHOD AND WARNING DEVICE THEREOF

(71) Applicant: Juluen Enterprise Co., Ltd., New Taipei City (TW)

(72) Inventors: Jhen-Fang Jian, New Taipei City (TW); Shih-Luan Chiu, New Taipei City (TW); Je-Yu Wu, New Taipei City (TW)

(73) Assignee: Juluen Enterprise Co., Ltd., New Taipei City (TW)

(21) Appl. No.: 16/669,482

(22) Filed: Oct. 30, 2019

(30) Foreign Application Priority Data
Feb. 18, 2019 (TW) 108105301

(51) Int. Cl. H04Q 9/14; G08B 5/36; G08B 3/10

(52) U.S. Cl. CPC H04Q 9/14; G08B 3/10; G08B 5/36

(57) ABSTRACT

A method for coordinating warning devices and a warning device are provided. The method is used to coordinate a plurality of warning devices. The method includes: providing a first warning device and at least one second warning device, wherein the first warning device has a first controller and each second warning device has a second controller; generating a first result and a second result according to an operation; operating the first controller in a first mode or a second mode according to the first result and the second result; and generating a first driving signal by the first controller if the first controller is in the first mode.

### CROSS-REFERENCE TO RELATED APPLICATION

This application claims the priority benefit of Taiwan application serial no. 108105301, filed on Feb. 18, 2019. The entirety of the above-mentioned patent application is hereby incorporated by reference herein and made a part of this specification.

### BACKGROUND

The disclosure relates to a coordination method and a warning device. More particularly, the disclosure relates to a coordination method applicable to a plurality of warning devices and a warning device applying the coordination method.

Warning devices coordinated by external electronic device are well known in the art. Thus, the coordinating of warning devices without the external electronic devices is a project aimed at improving by the warning industry.

### SUMMARY

A method for coordinating a plurality of warning devices of the disclosure includes: providing a first warning device and at least one second warning device, wherein the first warning device has a first controller, each second warning device has a second controller, and the first controller and each second controller mutually transmit signals via a telecommunication channel; generating a first result according to an operation, and generating a second result according to the operation; operating the first controller in a first mode or a second mode according to the first result and the second result; and generating a driving signal by the first controller if the first controller is in the first mode, wherein the first driving signal configures to produce a warning light or a warning sound on the first warning device.

A warning device for coordinating at least one other warning device of the disclosure includes a first controller and a peripheral circuit. Each of the at least one other warning device has a second controller. The warning device comprises a first controller and a peripheral circuit. The first controller is configured to be operated in a first mode or a second mode. The first controller generates a first result according to an operation, wherein the second controller generates a second result according to an operation. The peripheral circuit is coupled to the first controller and a telecommunication channel. The first controller and the second controller transmit signals via the telecommunication channel. The first controller is operated in the first mode or the second mode according to the first result and the second result. The first controller generates a driving signal via the peripheral circuit to drive the warning device to produce a warning light or a warning sound if the first controller is operated in the first mode.

Based on the above, the method of the invention is used to coordinate warning effects of the first warning device and the second warning device. The method is used to operate the first controller in the first mode or the second mode according to the first result and the second result, so as to coordinate the warning effects of the plurality of warning devices.

### BRIEF DESCRIPTION OF THE DRAWINGS

FIG. 1 is a flowchart of a first embodiment of the invention.

FIG. 2 is a schematic partial circuit diagram of a warning device of the invention.

FIG. 3A is a schematic waveform diagram of a third embodiment of the invention.

FIG. 3B is a schematic waveform diagram of a fourth embodiment of the invention.

FIG. 4 is a schematic partial circuit diagram of a warning device according to another embodiment of the invention.

FIG. 5A is a schematic partial circuit diagram of a warning device according to yet another embodiment of the invention.

FIG. 5B is a schematic partial circuit diagram of a warning device according to still another embodiment of the invention.

### DETAILED DESCRIPTION

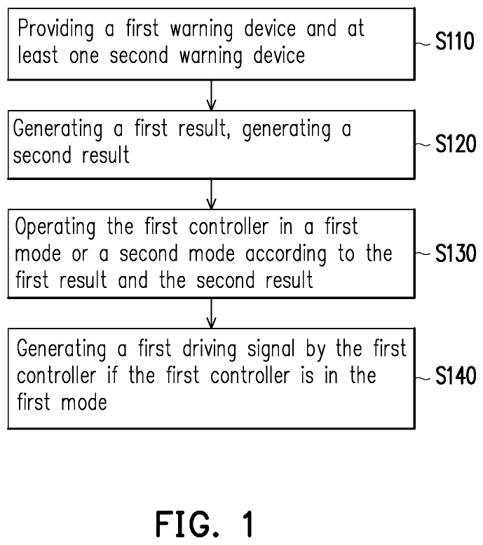

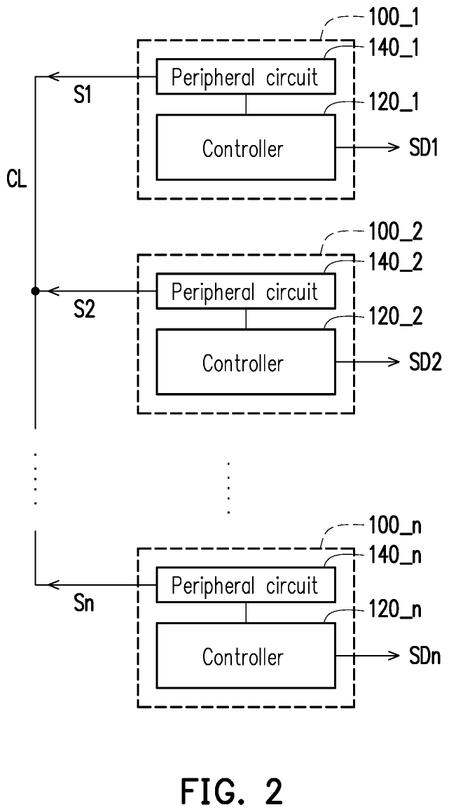

Referring to FIG. 1 and FIG. 2, FIG. 1 is a flowchart of a first embodiment of the invention, and FIG. 2 is a schematic partial circuit diagram of a warning device according to an embodiment of the invention.

First, a first warning device 100_1 and at least one second warning device 100_2 to 100_n are provided (step S110).

The first warning device 100_1 has a first controller 120_1. The second warning devices 100_2 to 100_n respectively have second controllers 120_2 to 120_n. The first controller 120_1 and each of the second controllers 120_2 to 120_n mutually transmit signals via a telecommunication channel CL. A manner of the transmission via the telecommunication channel CL may be wired or wireless.

The first controller 120_1 and the second controllers 120_2 to 120_n may be peripheral interface controllers (PICs), central processing units (CPUs), microprocessors (μPs), digital signal processors (DSPs), application specific integrated circuits (ASICs), micro control units (MCUs), microprocessor units (MPUs) or programmable logic devices (PLDs) or combinations thereof.

In addition, the first warning device 100_1 includes a peripheral circuit 140_1. Each of the second warning devices includes a peripheral circuit. For example, the second warning device 100_2 includes a peripheral circuit 140_2. The peripheral circuits 140_1 to 140_n of the warning devices 100_1 to 100_n are respectively coupled to the controllers 120_1 to 120_n and the telecommunication channel CL. The first controller 120_1 provides a driving signal SD1. The second controllers 120_2 to 120_n provide driving signals SD2 to SDn. The first controller 120_1 and the second controllers 120_2 to 120_n transmit synchronization signals S1 to Sn via the telecommunication channel CL and the peripheral circuits 140_1 to 140_n. The first controller 120_1 receives the synchronization signals S2 to Sn provided by the second controllers 120_2 to 120_n via the telecommunication channel CL.

The first warning device 100_1 may include at least one first warning light (not shown) or at least one first warning speaker (not shown). Each of the at least one first warning light produces a warning light according to the driving signal SD1 provided by the first controller 120_1. Each of the at least one first warning speaker produces a warning sound according to the driving signal SD1 provided by the first controller 120_1. Circuits and functions of the second warning devices 100_2 to 100_n are the same as those of the first warning device 100_1 and thus, will not be repeatedly described. Each of the second warning devices 100_2 to 100_n may include at least one second warning light (not shown) or at least one second warning speaker (not shown).

The first controller 120_1 generates an first result according to an operation. Each of the second controllers 120_2 to 120_n also generates a second result according to an operation (step S120).

In actual implementation, the first controller 120_1 may provide a first parameter P1 and a first target value M1. The second controllers 120_2 to 120_n may respectively provide second parameter P2-Pn and second target values M2-Mn. The first controller 120_1 performs an operation on the first parameter P1 (for example, increasingly or decreasingly), such that the first parameter gets close to the first target value (P1-→M1). The first parameter P1 after being operated by the first controller 120_1 for a first time T1 is equal to the first target value M1. The first controller 120_1 sets the first time T1 as the first result. Each of the second controllers 120_2 to 120_n performs the same operation on the second parameter, such that the second parameter get close to the second target values (P2→M2, P3→3 . . . Pn→Mn). The second parameter after being respectively operated by the second controllers 120_2 to 120_n for the second times T2-Tn is equal to the second target values. The second controllers 120_2 to 120_n set the second times T2-Tn as the first result.

The first controller 120_1 is operated in a first mode or a second mode according to the first result and the second result (step S130). Each of the second controllers 120_2 to 120_n is also operated in the first mode or the second mode according to the result. If the first time T1 is less than the second times T2-Tn, the first controller 120_1 is operated in the first mode, and the second controllers 120_2 to 120_n are operated in the second mode. If the second time T2 at which one of the second controllers, e.g., the second controller 120_2, operates is less than the first time T1 and the second times T3-Tn at which the other second controllers 120_3 to 120_n operate, the second controller 120_2 is operated in the first mode, and the first controller 120_1 and the other second controllers 120_3 to 120_n are operated in the second mode. The parameter P1-Pn and the target values M1-Mn may be random values generated by a random number table or a random number generator, or may be default values built in each of the controllers 120_1 to 120_n.

If the first controller 120_1 is operated in the first mode, the first controller 120_1 generates a driving signal to drive the first warning device 100_1 to produce the warning light or the warning sound (step S140). If the first controller 120_1 is operated in the second mode, the first controller 120_1 stops generating the driving signal to stop driving the first warning device 100_1 from producing the warning light or the warning sound. Thus, according to the synchronization signals S2 to Sn and the telecommunication channel CL, each of the warning devices 100_1 to 100_n synchronously produces the warning light or the warning sound, thereby coordinating warning effects of the plurality of warning devices 100_1 to 100_n.

If the first controller 120_1 is operated in the first mode, and the second controllers 120_2 to 120_n are operated in the second mode, the first controller 120_1 generates the synchronization signal S1 to each of the second controllers 120_2 to 120_n. Each of the second controllers 120_2 to 120_n drives the second warning devices 100_2 to 100_n according to the synchronization signal S1. If the second controller 120_2 is operated in the first mode and the first controller 120_1 and the other second controllers 120_3 to 120_n are operated in the second mode, the first controller 120_1 and the other second controllers 120_3 to 120_n receive the synchronization signal S2 generated by the second controller 120_2 to drive the first warning device 100_1 and the second warning devices 100_3-100_n corresponding to the other second controllers 120_3 to 120_n.

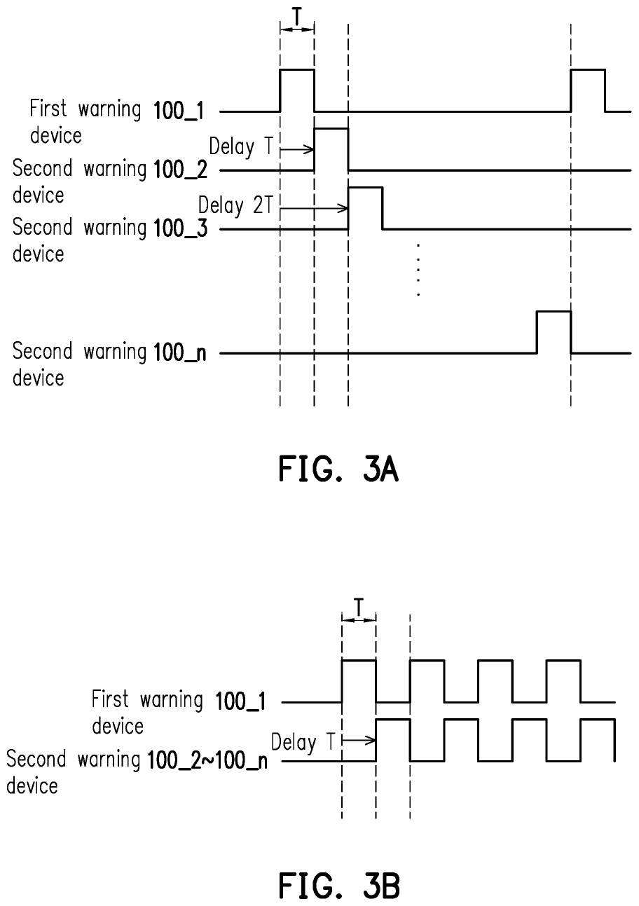

The first warning device 100_1 and the second warning devices 100_2 to 100_n may sequentially produce the warning light or the warning sound by operating the driving signals SD1 to SDn having multiple phases or by delaying the driving signals SD1 to SDn. Referring to FIG. 3A, FIG. 3A is a schematic waveform diagram of a third embodiment of the invention. For example, the first warning device 100_1 is driven according to the driving signal SD1 (wherein each of the driving signals SD1 to SDn is a square wave or a sine wave having a preset period T), and the second warning device 100_2 is driven by delaying the driving signal SD2 by a preset period T, another second warning device 100_3 is driven by delaying the driving signal SD3 by two preset periods, 2T, yet another second warning device is driven by delaying the driving signal by three preset periods, 3T, and so on. Thereby, the first warning device 100_1 and the second warning devices 100_2 to 100_n may sequentially produce the warning light or produce the warning sound. Additionally, as illustrated in FIG. 3B, according to the manner that the second warning devices 100_2 to 100_n delay the driving signals SD2 to SDn, the first warning device 100_1 and the second warning devices 100_2 to 100_n may also alternately produce the warning light or the warning sound. In addition, a part of the second warning devices and the first warning device may synchronously produce the warning light or the warning sound, and the other second warning devices and the first warning device may alternately produce the warning light or the warning sound.

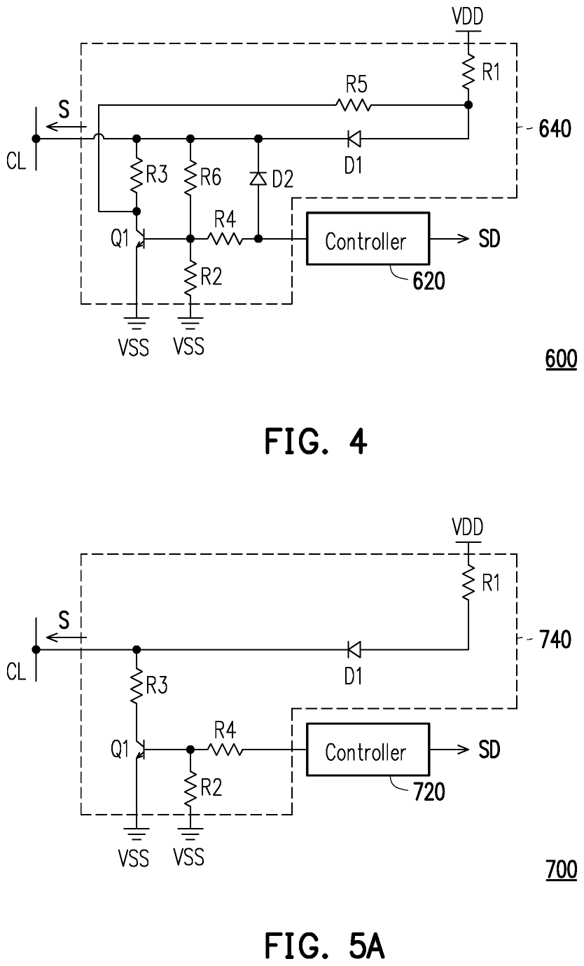

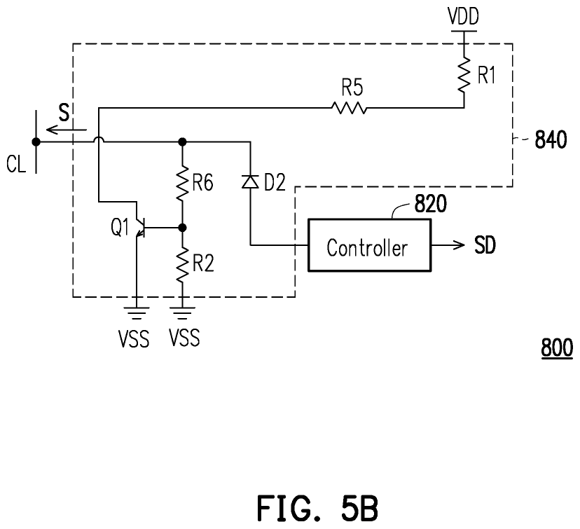

Referring to FIG. 4, FIG. 4 is a schematic partial circuit diagram of a warning device according to another embodiment of the invention. A warning device 600 may be operated in a first circuit mode (as illustrated in FIG. 5A) or a second circuit mode (as illustrated in FIG. 5B). In actual implementation, in order to save cost, a user may select to independently use a circuit illustrated in FIG. 7A, or independently use a circuit illustrated in FIG. 5B. In the embodiment illustrated in FIG. 4, a peripheral circuit 640 includes resistors R1-R6, diodes D1 and D2 and a transistor Q1. A first terminal of the resistor R1 is coupled to a system voltage VDD, a second terminal of the resistor R1 is coupled to a controller 620. A base of the transistor Q1 is coupled to the controller 620. The controller 620 may independently provide a driving signal SD. A collector of the transistor Q1 is coupled to the second terminal of the resistor R1. An emitter of the transistor Q1 is coupled to a reference level VS S. A first terminal of the resistor R2 is coupled to the base of the transistor Q1. A second terminal of the resistor R2 is coupled to the reference level VSS. An anode of the diode D1 is coupled to the second terminal of the resistor R1. A cathode of the diode D1 is coupled to the telecommunication channel CL used for transmitting a synchronization signal S. The resistor R3 is coupled between the cathode of the diode D1 and the collector of the transistor Q1. The resistor R4 is coupled to between the controller 620 and the base of the transistor Q1. An anode of the diode D2 is coupled to the resistor R and the controller 620. A cathode of the diode D2 is coupled to the telecommunication channel CL. The resistor R5 is coupled to the collector of the transistor Q1. The resistor R6 is coupled between the telecommunication channel CL and the base of the transistor Q1.

In view of the foregoing, the method of the invention is used to coordinate the warning effects of the plurality of warning devices. The method is used to operate the first controller in the first mode or the second mode according to the first result and the second result, such that the first controller is operated in the first mode or the second mode, thereby coordinating the warning effects of the plurality of warning devices.

1. A method for coordinating a plurality of warning devices, comprising:
providing a first warning device and at least one second warning device, wherein the first warning device has a first controller, each of the at least one second warning device has a second controller, and the first controller and each of the at least one second controller mutually transmit signals via a telecommunication channel;
generating a first result according to an operation, and generating a second result according to the operation;
operating the first controller in a first mode or a second mode according to the first result and the second result; and
generating a first driving signal by the first controller if the first controller is in the first mode, wherein the first driving signal configures to produce a warning light or a warning sound on the first warning device.

2. The method of claim 1, wherein the first controller stops driving the first warning device if the first controller is in the second mode.

3. The method of claim 1, comprising the step of: generating a synchronization signal from the first controller to each of the at least one second controller via the telecommunication channel if the first controller is in the first mode, wherein the synchronization signal configures to drive each of the at least one second warning device by the at least one second controller according to the synchronization signal.

4. The method of claim 1, wherein the step of generating the first result comprises: generating the first result according to a first parameter provided by the first controller, and
wherein the step of generating the second result comprises: generating the second result according to a second parameter provided by the second controller.

5. The method of claim 1, wherein step of generating the first result comprises: generating the first result according to a first parameter and a first target value provided by the first controller, and
wherein the step of generating the second result comprises: generating the second result according to a second parameter and a second target value provided by the second controller.

6. The method of claim 5, wherein the step of generating the first result comprises: set a first time required to increase or decrease the first parameter value to approach the first target value as the first result; and
wherein the step of generating the second result comprises: set a second time required to increase or decrease the second parameter value to approach the second target value as the second result.

7. The method of claim 1, wherein the first warning device comprises at least one first warning light or at least one first warning speaker, and each of the at least one second warning device comprises at least one second warning light or at least one second warning speaker.

8. A warning device for coordinating at least one other warning device, wherein the at least one other warning device has a second controller, the warning device comprising:
a first controller, configured to operate in a first mode or a second mode, wherein the first controller generates a first result according to an operation, wherein the second controller generates a second result according to an operation; and
a peripheral circuit, coupled to the first controller and a telecommunication channel, and the first controller and the second controller transmitting signals via the telecommunication channel,
wherein the first controller is operated in the first mode or the second mode according to the first result and the second result, and the first controller generates a first driving signal via the peripheral circuit to drive the warning device to produce a warning light or a warning sound if the first controller is operated in the first mode.

9. The warning device of claim 8, wherein the first controller stops driving the warning device if the warning device is operated in the second mode.

10. The warning device of claim 8, wherein the first controller generates a synchronization signal to each of the at least one second controller via the telecommunication channel if the first controller is operated in the first mode, and each of the at least one second controller drives the at least one other warning device according to the synchronization signal.

11. The warning device of claim 8, wherein the first controller generates the first result according to a first parameter provided by the first controller, wherein the second controller generates the second result according to a second parameter provided by the second controller.

12. The warning device of claim 8, wherein the first controller generates the first result according to a first parameter and a first target value provided by the first controller, wherein the second controller generates the second result according to a second parameter and a second target value provided by the second controller.

13. The warning device of claim 12, wherein the first controller set a first time required to increase or decrease the first parameter value to approach the first target value as the first result, wherein the second controller set a second time required to increase or decrease the second parameter value to approach the second target value as the second result.

14. The warning device of claim 8, wherein the warning device comprises at least one first warning light or at least one first warning speaker, and each of the at least one warning device comprises at least one second warning light or at least one second warning speaker.

15. The warning device of claim 8, wherein if the warning device is in a first circuit mode, the peripheral circuit comprises:
a first resistor, having a first terminal coupled to a system voltage;
a transistor, having a base coupled to the first controller, a collector coupled to a second terminal of the first resistor and an emitter coupled to a reference level;
a second resistor, having a first terminal coupled to a base of the transistor, and a second terminal coupled to the reference level;
a diode, having an anode coupled to the second terminal of the first resistor and the first controller;
a third resistor, having a first terminal coupled to a cathode of the diode, and a second terminal coupled to the collector of the transistor; and
a fourth resistor, coupled between the first controller and the base of the transistor.

16. The warning device of claim 8, wherein if the warning device is operated in a second circuit mode, the peripheral circuit comprises:
a first resistor, having a first terminal coupled to a system voltage;
a transistor, having a base coupled to the first controller, a collector coupled to the second terminal of the first resistor and an emitter coupled to a reference level;
a second resistor, having a first terminal coupled to the base of the transistor and a second terminal coupled to the reference level;
a diode, having an anode coupled to the first controller;
a third resistor, having a first terminal coupled to a second terminal of the first resistor and the first controller and a second terminal coupled to the collector of the transistor; and
a fourth resistor, coupled between a cathode of the diode and the base of the transistor.
